(19) United States
(12) Patent Application Publication
(10) Pub. No.: US 2013/0238665 A1
(43) Pub. Date: Sep. 12, 2013

(54) MANAGING RECORDS DISPLAYED IN A TREE LIST

(71) Applicant: Vincent Sequin, San Diego, CA (US)

(72) Inventor: Vincent Sequin, San Diego, CA (US)

(21) Appl. No.: 13/885,017

(22) PCT Filed: Dec. 10, 2010
(86) PCT No.: PCT/US10/59943

§ 371 Date: May 13, 2013

(51) Int. Cl. G06F 17/30

(52) U.S. Cl. CPC G06F 17/30327
USPC 707/797

(57) ABSTRACT

A method is provided for managing the number of records displayed in a tree list 120. A limit 132 can be set on concurrently displayed nodes and records on a user device 110. A recently accessed node of a tree list 120 can be selected to be displayed on the user device 110. An oldest accessed node of the tree list 120 displayed can be collapsed when the number of concurrently displayed nodes and records exceeds the limit 132. The recently accessed node of a tree list 120 can be expanded and displayed on the user device 110.

### BACKGROUND

Databases are used to store and retrieve data. Database applications can store thousands or millions of records on servers. Databases and related applications can compile and organize data and display the data using viewers, client applications, and browsers. Some data can be organized and displayed in a tree-like structure or a tree list.

The tree lists can have nodes that can expand and collapse the records to be accessed and viewed.

### BRIEF DESCRIPTION OF THE DRAWINGS

FIG. 1 is an illustration of a system for managing records displayed in a tree list in accordance with an example;

FIG. 2 is an illustration of a system for managing records displayed in a tree list in accordance with an example;

FIG. 3 is an illustration of a system for managing records displayed in a tree list using a network in accordance with an example;

FIG. 4A is an illustrative diagram showing a displayed expanded tree list in accordance with an example;

FIG. 4B is an illustrative diagram showing a displayed collapsed tree list in accordance with an example;

FIG. 4C is an illustrative diagram showing a displayed tree list in accordance with an example;

FIG. 4D is an illustrative diagram showing a displayed tree list in accordance with an example;

FIG. 4E is an illustrative diagram showing a displayed tree list in accordance with an example; and

FIG. 5 is a flowchart illustrating a method for managing the number of records displayed in a tree list in accordance with an example.

### DETAILED DESCRIPTION

Alterations and further modifications of the illustrated features, and additional applications of the principles of the examples, which would occur to one skilled in the relevant art and having possession of this disclosure, are to be considered within the scope of the disclosure. The same reference numerals in different drawings represent the same element.

Tree lists can have nodes used to organize and display records. A tree list or tree structure can be a way of representing the hierarchical nature of a structure in a graphical form. A tree list can be a data structure with a set of linked nodes. The nodes can represent categories of records. The records can be data elements in a database or leaves on a tree structure. The categories of records may be further subdivided or subcategorized and represented by sub-nodes or child nodes of parent nodes. Parent nodes may be referred to as trunk nodes and child nodes may be referred to as branch nodes.

When viewing a tree list, an original set of parent nodes may be displayed as collapsed nodes. A user may select a parent node to view the hidden child nodes and records of a parent node. When a node is selected, the node can expand to show the child nodes or records of the parent node. The child nodes can be selected and expanded to show more child nodes or grandchild nodes of the original parent nodes. So a node may be both a parent node to nodes lower in the tree list hierarchy and a child to nodes higher in the tree list hierarchy.

When an expanded node is selected, the node may collapse to hide the child nodes and records associated with the expanded node or parent node. In other words, selecting a node may toggle the node between a collapsed or closed state where the child nodes and records associated with the node are hidden or not viewable and an open or expanded state where the child nodes and records associated with the node are visible and viewable. The user can continue to open other parent nodes or expand child nodes of opened parent nodes.

Each record opened and each child node made viewable by expanding nodes can use a portion of memory or request data from the database system. Each record opened and each child node may be loaded into memory on a user system. Sometimes, a user may continuously expand nodes without closing earlier expanded nodes. Each expanded node can reveal hundreds or thousands of records and/or child nodes. Displaying a large number of records and/or nodes can use a large amount of memory, slow down the functionality of the system, and in some cases crash the system. Closing or collapsing unused nodes can reduce the memory usage, reduce the system load, improve the functionality and speed of the system, and reduce the number of system crashes due to the expanded nodes. Usually nodes and records accessed more recently in time can be more relevant to the user, so collapsing older or least recently used nodes may have less impact on the user's viewing and use of the tree list.

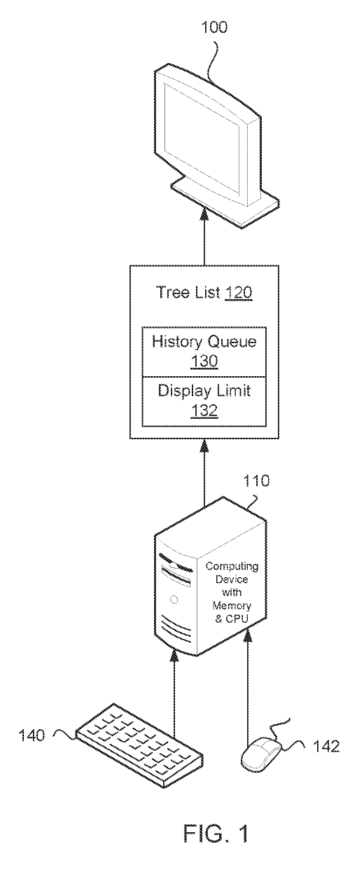

A system and method may be used to manage the number of records in a tree list 120, as illustrated in FIG. 1. The tree list may use a computing device 110, referred to as a user device for generating or displaying a tree list with expandable nodes. The computing device can be a computer, a server, portable mobile device, wireless device, or other device for generating, transmitting, or displaying a tree list with expandable nodes. The tree list generated or transmitted by the computing device may be displayed on a display 100, which can be coupled to the computing device.

A history queue 130 and a display limit 132 may be associated with the tree list. The history queue may record an access order or an order in which nodes are expanded and collapsed. The order may include a time stamp, which can include a time and date of the last node access. The system may limit the number of nodes and records concurrently displayed using the display limit or a load limit.

A user may enter a command to select nodes, records, or objects in the tree list using an input device 140 or select the nodes and records with a selection device 142. The input device may be a computer keyboard, voice recognition device, touch screen, selection device, or other similar device. The selection device may be a computer mouse, electronic pen, touch screen, or other similar device. The computing device may include memory and a central processing unit (CPU). Memory may be RAM, flash drive, or other volatile or non-volatile medium for storing electronic data.

The memory can hold the display limit which can set a limit set on the number of concurrently displayed nodes and records of the tree list. Each of the concurrently displayed nodes and records may be loaded prior to being displayed. The memory can save the history queue of an access order for a plurality of nodes of the tree list. The tree list can collapse an oldest accessed node of the history queue using the CPU when the number of concurrently displayed nodes and records exceeds the display limit when a recently accessed node of a tree list. The tree list can expand the recently accessed node of the tree list using the CPU to display the child nodes and records of the recently accessed node on the display or display unit.

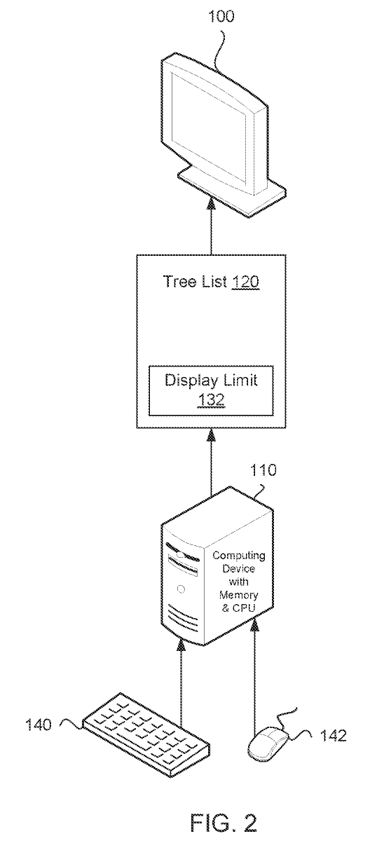

In another example, a display limit may be associated with the tree list without the history queue, as illustrated in FIG. 2. The tree list may collapse a node when the display limit is reached.

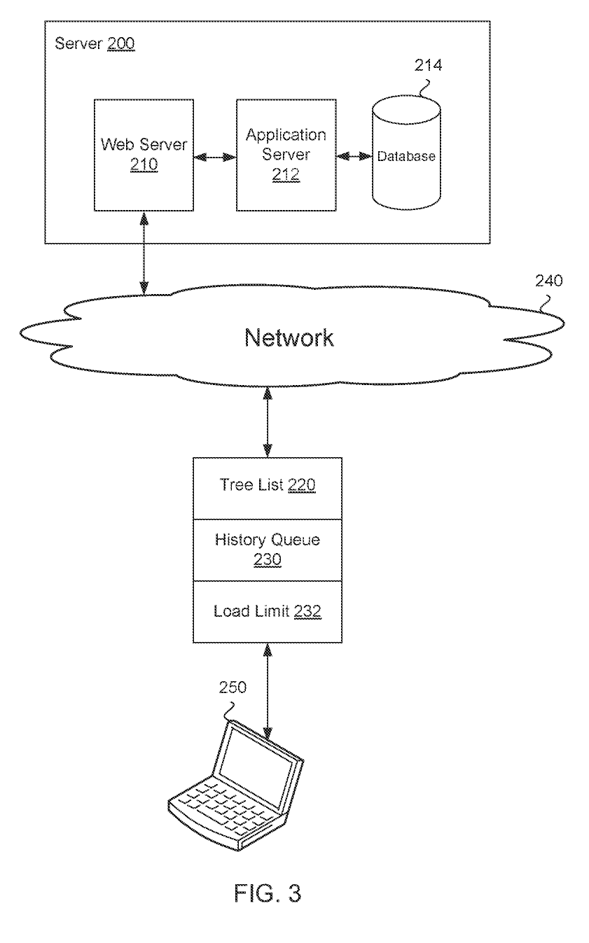

As illustrated in FIG. 3, the tree list 220 may be generated using a server system 200. The server 200 can include a web server 210, an application server 212, and a database 214. The data for a tree list may be generated by a database of an application server and sent to a browser or client application on a user device 250 via a web server through a network 240 or Internet. A history queue 230 and load limit 232 may be associated with the server system generating the tree list data and the load limit may be derived from the server system configuration or limitations. The load limit may be a value that limits the number of concurrently displayed nodes and records of the tree list. In another example, the history queue and load limit may be associated with the user device. The user device may have a set amount of memory and the load limit may set a limit on the concurrently displayed nodes and records of the tree list, so the memory of the user device can display the nodes and records of the tree list without leading to resource starvation or slowing down the refreshing, drawing, or rendering of the display.

A method for managing the number of records displayed in a tree list may be associated with data organized in the hierarchal tree-like structure. The nodes may be organized by query fields, selected fields, or attributes in the record data. The nodes of the tree list may allow a user to expand and collapse the nodes to access records of a specified category or records by specified record attributes or fields. The tree list may be large enough that the tree list cannot concurrently display or load all the records and expanded nodes.

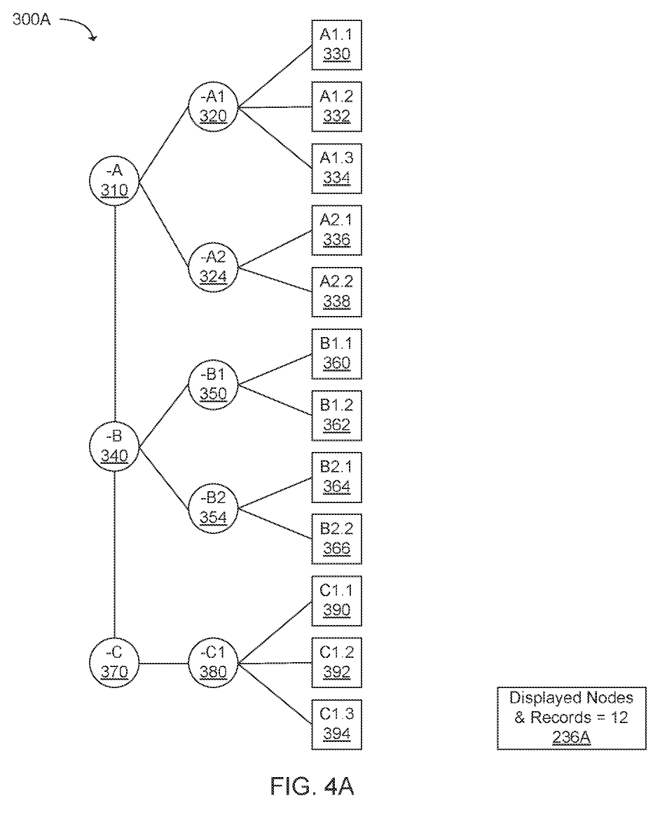

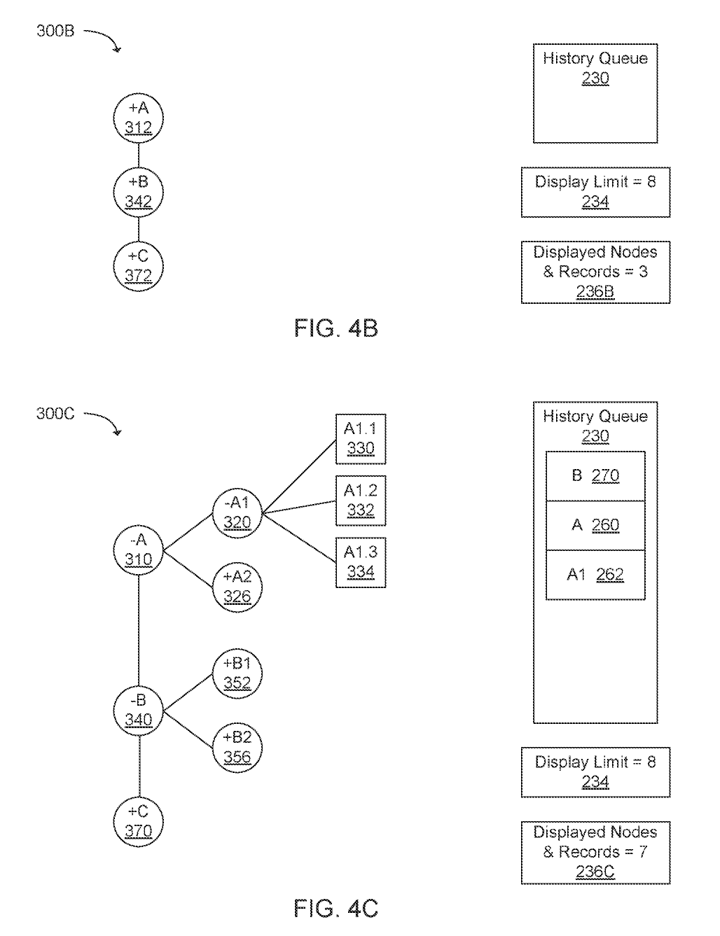

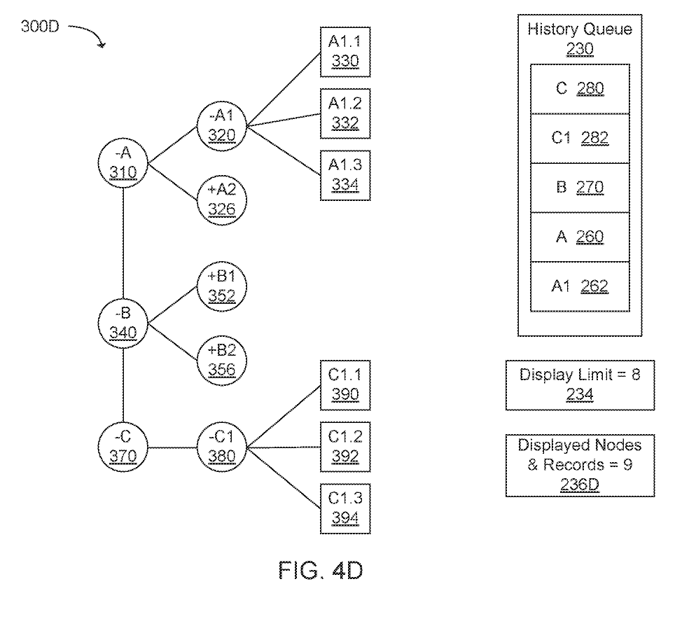

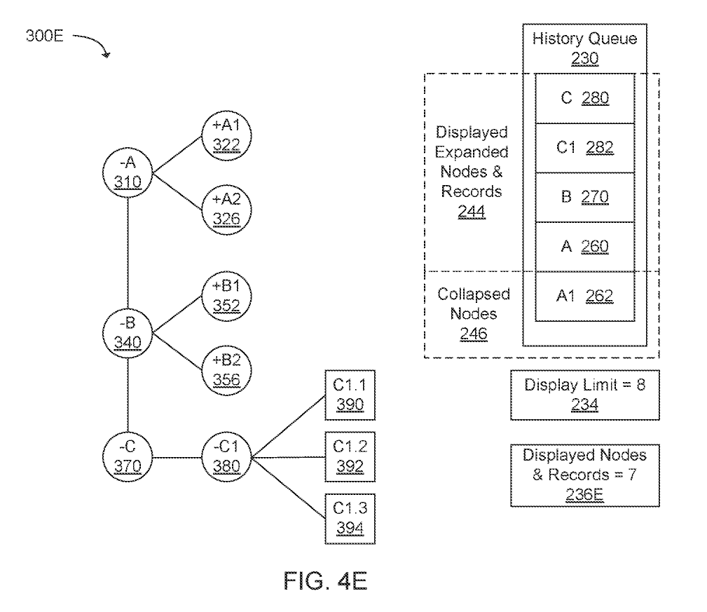

FIGS. 4A-4E illustrate a method and mechanism to limit the concurrently displayed nodes and records on the user device. Although FIGS. 4A-4E uses a limit of eight and small number of concurrently displayed nodes and records on the user device for simplicity in illustrating the method, the limit can set to thousands of concurrently displayed nodes and records. The nodes in the figures may have a plus (+) or a minus (−) prefix on the nodes. The plus (+) indicates an expanded node and the minus (−) indicates a collapsed node. FIG. 4A provides an example of a tree list 300A with expanded nodes. The tree list has three original expanded parent nodes of A 310, B 340, and C 370. Node A includes the expanded child nodes of A1 320 and A2 324. Node A1 includes the records of A1.1 330, A1.2 332, and A1.3 334. Node A2 includes the records of A2.1 336 and A1.2 338. Node B includes the expanded child nodes of B1 350 and B2 354. Node B1 includes the records of B1.1 360 and B1.2 362. Node B2 includes the records of B2.1 364 and B1.2 366. Node C includes the expanded child node of C1 380. Node C1 includes the records of C1.1 390, C1.2 392, and C1.3 394. The fully expanded tree list has 12 displayed nodes and records 236A. In the example, displaying all 12 records may have an undesirable effect like overloading the system, delaying the rendering of the display, or crashing the system. The method provides for a mechanism to limit the concurrently displayed nodes and records on the user device.

Initially, FIG. 4B illustrates that the tree list 300B may be displayed to the user on the user device with the original collapsed parent nodes of A 312, B 342, and C 372. The display limit 234 may be set for a max load of eight to allow eight displayed nodes and records. The display limit may be hard coded or varied based on a server system configuration, memory, and/or other hardware or a user system configuration, memory, and/or other hardware. The history queue 230 may be empty when the tree list initially displays. The history queue may be a stack or list stored in memory. The history queue may be a first-in first out (FIFO) stack. The history queue may record operations and actions taken by a user related to the tree list. The history queue may record an entry corresponding to each operation taken. The history queue may record an expansion of a node, referred to as a queue node. The history queue can places a recently accessed queue node or a recently accessed queue record at the top of the history queue. Each loaded or displayed record and collapsed node may contribute to the number or count of the displayed nodes and records. Each expanded node may not be included in the number or count of the displayed nodes and records. In the example of FIG. 4B, the three originally displayed collapsed parent nodes of A, B, and C contribute a count of three to the displayed nodes and records 236B count for each of the nodes. Since no records are displayed with the collapsed parent nodes in the example of FIG. 4B, the records do not contribute to the displayed nodes and record count. The displayed nodes and record count can be compared against the display limit after each user node selection or node expansion. Since the displayed nodes and record count is less than the display limit, the display of the tree list may not change at this point. Nodes A, B, C may be referred to as concurrently displayed nodes. The concurrently displayed node may include unexpanded nodes (e.g. A, B, and C).

A user may select node A 310 followed by selecting node A1 320 and node B 340, as illustrated in FIG. 4C. The user on the user device may select node A of the tree list 300C for expansion to view child nodes A1 322 and A2 326. As a result, the selection of node A, an A queue node representing the selection may be added to the top of history queue 230 (intermediate step not shown). The A queue node may be marked with a time stamp. The total number of displayed nodes and records due to the expansion may be determined. The displayed nodes and record count for expanding node A increases from three to four (intermediate step not shown). The expanded node A no longer adds to the count, but collapsed nodes A1 and A2 do add to the count. Since the displayed nodes and record count is less than the display limit of eight, the method continues to expand node A to display child nodes A1 and A2.

The user may further select node A1 320 for expansion to view the records of A1.1 330, A1.2 332, and A1.3 334. As a result of the selection of node A1, an A1 queue node representing the selection may be added to the top of history queue 230 (intermediate step not shown). Since A is a parent node of node A1, node A may be refreshed with an access time stamp at the same time or near the same time as the A1. A second A queue node may be added to the history queue, so the history queue from the most recent queue node (or queue record) to the oldest queue node (or queue record) in the example has a second A queue node, the A1 queue node, and a first A queue node (i.e., A, A1, A; not implemented in FIG. 4C). A duplicate parent queue node representing the parent node of the child node may be added to the history queue after the child queue node is added representing that the child node is selected, so a plurality of queue nodes in the history queue may represent one node (e.g., node A; intermediate step not shown).

In another example, the parent queue node of child node may be moved in the history queue 230 to be more recent than the child node. For example, the A queue node 260 may be moved in the history queue to be more recent than the A1 queue node 262, as illustrated in FIG. 4C. The total number of displayed nodes and records due to the expansion may be determined. The displayed nodes and record count for expanding node A1 can then increase from four to six (intermediate step not shown). The expanded node A1 no longer adds to the count, but the records A1.1, A1.2, and A1.3 do add to the count. Since displayed nodes and record count is less or equal to than the display limit of eight, the method continues to expand node A1 to display the records of A1.1, A1.2, and A1.3, as illustrated in FIG. 4C. The display limit may be greater than the displayed nodes and record count or may be greater than or equal to the displayed nodes and record count. The concurrently displayed records may include records of an expanded node (e.g., A1.1. A1.2, and A1.3).

If a user opens, views, or performs an operation on a record, an access queue record (not shown) may be added to the history queue corresponding to the record that was accessed. The parent queue nodes of the record may then be refreshed with an access time stamp at the same time as the record queue node time stamp or the time of the record access, so the parent node of a recently accessed record is not collapsed when the parent node queue has an oldest access time stamp of the displayed nodes and records. In another example, the parent queue nodes of the accessed record may be moved in the history queue to be more recent than the accessed record, so the parent node of a recently accessed record is not collapsed when the parent node queue is at the bottom of the history queue with other displayed queue nodes and displayed queue records.

Continuing with the method, the user may select node B 340 for expansion to view child nodes B 352 and B2 356. As a result of the selection of node B, a B queue node 270 representing the selection may be added to the top of history queue 230. The B queue node may be placed in the history queue before the A queue node 260 and the A1 queue node 262 representing that the B node is more recently accessed than the A and A1 node, as illustrated in FIG. 4C. The B queue node may have a time stamp later in time than the A and A1 queue nodes. The total number of displayed nodes and records due to the expansion may be determined. The displayed nodes and records 236C count for expanding node B increases from six to seven. The expanded node B no longer adds to the count, but collapsed nodes B1 and B2 do add to the count. Since displayed nodes and record count is less than the display limit of eight, the method continues to expand node B to display child nodes B1 and B2, as illustrated in FIG. 4C.

The user may select node C 370 followed by selecting node C1 380, as illustrated in FIG. 4D. The user on the user device may select node C of the tree list 300D for expansion to view child node C1. As a result the selection of node C, a C queue node representing the selection may be added to the top of history queue (intermediate step not shown). The total number of displayed nodes and records due to the expansion may then be determined. The displayed nodes and record count for expanding node C does not change and remains at seven (intermediate step not shown). The expanded node C no longer adds to the count, but collapsed node C1 does add to the count. Since the displayed nodes and record count is less than the display limit of eight, the method continues to expand node C to display child node C1.

The user may further select node C1 380 for expansion to view the records of C1.1 390, C1.2 392, and C1.3 394. C1 may be referred to as a recently accessed node of the tree list. As a result the selection of node C1, a C1 queue node representing the selection may be added to the top of history queue 230 (intermediate step not shown).

Since node C 370 is a parent node of node C1, node C may be refreshed with an access time stamp at the same time or near the same time as the C1. A second C queue node may be added to the history queue sandwiching the C1 queue node between a first C queue node and the second C queue node (not implemented in FIG. 4D). In another example, the C queue node 280 may be moved in the history queue to be more recent than the C1 queue node 282, as illustrated in FIG. 4D, so the node C will not collapse before the node C1.

The total number of displayed nodes and records due to the expansion can be determined. The displayed nodes and records 236D can count for expanding node A1 and the count can increase from seven to nine. The expanded node C1 no longer adds to the count, but the records C1.1, C1.2, and C1.3 do add to the count. Since the displayed nodes and record count is greater to than the display limit of eight, the method can collapse an oldest accessed node of the tree list until the displayed nodes and record count is within the display limit of eight. The oldest accessed node of the tree list can be determined by the oldest displayed queue node in the history queue.

For example, in FIG. 4D the oldest displayed accessed node is the expanded node A1 320 represented by the A1 queue node 262 in the history queue 320. The A1 node 322 may be collapsed or closed to hide the records of A1.1, A1.2, and A1.3, as illustrated in FIG. 4E. The records and child nodes of a collapsed node may remain loaded in memory for a limited number of subsequent selections or operations to allow a recently collapsed node to be reopened or redisplayed without additional loading of the system. The history queue may use a first-in first-out (FIFO) mechanism for collapsing nodes. The displayed nodes and records 236E count for collapsing node A 1 can decrease from nine to seven. The records A1.1, A1.2, and A1.3 no longer add to the count, but the collapsed node A1 does add to the count. The recently selected node C1 or a recently accessed node can expand displaying the records of C1.1 390, C1.2 392, and C1.3 394.

The expansion of the recently accessed node may occur before or after the collapse the oldest accessed node. The displayed nodes and record count may be determined after each node is collapsed or expanded and compared with the display limit.

In another example, the history queue may include a category of displayed expanded queue nodes and queue records 244 and a category of collapsed queue nodes 246, as illustrated in FIG. 4E. The oldest accessed node, which is expanded and displayed, may move from the displayed expanded nodes and records category to the collapsed nodes category when the oldest accessed node is collapsed. The recently collapsed oldest accessed node may move to the top of the collapsed nodes category. So when a user views the history queue and the collapsed nodes category, the user can select the recently collapsed queue nodes for re-expansion. In another example, a history queue may include an expanded node history queue and a collapsed node history queue. A list of expanded queue nodes may be shown or listed in the history queue before the collapsed queue nodes

The history queue may be accessible and viewable to the user in one example configuration. If a node and the displayed records of that node are collapsed using the method, the collapsed queue node in the history queue may be listed at the top of the collapsed node history queue or the collapsed nodes category. If a user still wants to view the node and the displayed records of that node, then the user can select the collapsed queue node from the history queue. Selecting the collapsed queue node may move the collapsed queue node to the top of the expanded node history queue or the displayed expanded nodes and records category, and the collapsed queue node may then be referred to as the recently accessed queue node. Selecting the collapsed queue node may use the method to collapse the next oldest accessed node (accessed more recently than the collapsed node before being selected by a user) and display the nodes and records of the collapsed queue node. The collapsed node may still have the associated child nodes and records still loaded temporarily in memory when the user reselects the collapsed node for expansion for a few selections or operations after the collapsed node is collapsed to allow a user to reselect the node without reloading the associated child nodes and records.

In another example, the access of a child node may not refresh the parent queue node in the history queue. The method may determine if the proposed node to be collapsed has a child queue node or queue record in the history queue representing an access more recently or later in time than the proposed node to be collapsed. If a child queue node or queue record in the history queue was accessed more recently in time than the proposed queue node corresponding to the proposed node to be collapsed then a proposed queue node may be refreshed with the time stamp of the child queue node or queue record, moved in front of the child queue node or queue record in the history queue, moved behind the child queue node or queue record in the history queue, or skipped for node collapsing. If the proposed node is skipped for node collapsing, the next oldest node or a more recent node than the proposed node may be collapsed.

When a parent node includes a large number of child nodes and records with a first level expansion, the child nodes and records of the parent node may be subdivided or grouped into synthetic sub-groups, constructed sub-groups, or temporary sub-groups. Each synthetic sub-group can correspond to a plurality of synthetic sub-group nodes. A number of the synthetic sub-group nodes can be less than the total number of child nodes and records of the parent node. The synthetic sub-group nodes can create another layer of nodes between the parent node and the child nodes and records for organizing the tree list and to reduce the number of child nodes and records being opened concurrently. The synthetic sub-group nodes may be displayed instead of the original child nodes and records associated with the parent node. Selecting a synthetic sub-group node may expand the selected synthetic sub-group node and display the child nodes and records in a sub-group corresponding to the selected synthetic sub-group node while leaving remaining synthetic sub-group nodes collapsed and keeping the child nodes and records associated with the unselected synthetic sub-group nodes hidden or concealed from the user's view.

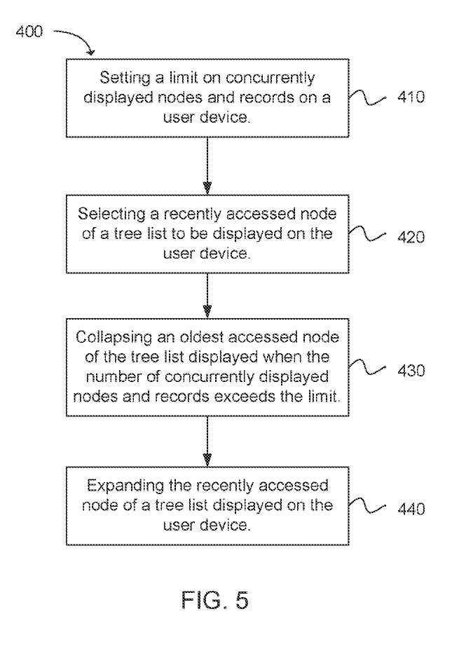

Another example provides a method 400 for managing the number of records displayed in a tree list, as shown in the flow chart in FIG. 5. The method includes the operation of setting a limit on concurrently displayed nodes and records on a user device, as in block 410. The operation of selecting a recently accessed node of a tree list to be displayed on the user device follows, as in block 420. The next operation of the method may be collapsing an oldest accessed node of the tree list displayed when the number of concurrently displayed nodes and records exceeds the limit, as in block 430. The method further includes expanding the recently accessed node of a tree list displayed on the user device, as in block 440.

The method and system may allow multiple relevant nodes and records to be concurrently opened, viewed, and operated on by a user on different branches of the tree list. The method can automatically close branches and nodes and maintain system stability, so a user does not have to be concerned about closing the branches and nodes.

The method and system for managing the number of records displayed in a tree list may be implemented using a computer readable medium having executable code embodied on the medium. The computer readable program code may be configured to provide the functions described in the method. The computer readable medium may be a RAM, EPROM, flash drive, optical drive, magnetic hard drive, or other medium for storing electronic data. Additionally, the method and system for managing the number of records displayed in a tree list may be downloaded as a computer program product transferred from a server or remote computer to a requesting or client device by way of machine readable data signals embodied in a carrier wave or other propagation medium.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts described. Accordingly, it is not intended that the invention be limited, except as by the claims set forth below.

What is claimed is:

1. A method for managing records displayed in a tree list 120, comprising:
setting a limit 132 on concurrently displayed nodes and records in a tree list 120 on a user device 110;
selecting a recently accessed node of the tree list 120 to be displayed on the user device 110;
collapsing an oldest accessed node of the tree list 120 displayed when a number of concurrently displayed nodes and records exceeds the limit 132 on concurrently displayed nodes; and
expanding the recently accessed node of a tree list 120 displayed on the user device 110.

2. The method of claim 1, wherein concurrently displayed nodes include unexpanded nodes and records of an expanded node.

3. A method for managing the number of records displayed in a tree list 120, comprising:
setting a limit 132 on concurrently displayed nodes and records in a tree list 120 on a user device 110;
saving a history queue 130 in memory of an access order of a plurality of nodes and records of the tree list 120;
selecting a recently accessed node of the tree list 120 to be displayed on a user device 110;
collapsing an oldest accessed node of the tree list 120 displayed determined by the history queue 130 when the number of concurrently displayed nodes and records exceeds the limit 132 on concurrently displayed nodes; and
expanding the recently accessed node of a tree list 120 displayed on the user device 110.

4. The method of claim 3, wherein the history queue saves a list of expanded queue nodes and collapsed queue nodes where the expanded queue nodes are shown in the history queue before the collapsed queue nodes.

5. The method of claim 3, wherein saving the history queue places a recently accessed queue node or a recently accessed queue record at the top of the history queue.

6. The method of claim 3, further comprising determining an additional number of nodes and records of the recently accessed node to be displayed due to node expansion before expanding the recently accessed node.

7. The method of claim 6, wherein collapsing an oldest accessed node occurs after a sum of the additional number of the recently accessed nodes and records and the concurrently displayed nodes and records exceeds the limit.

8. The method of claim 6, further comprising:
grouping the additional number of nodes and records of the recently accessed node to be displayed into a plurality of synthetic sub-groups where each synthetic sub-group corresponds to a plurality of synthetic sub-group nodes and a number of the synthetic sub-group nodes is less than the additional number of nodes and records of the recently accessed node to be displayed;
displaying the synthetic sub-group nodes;
selecting a selected synthetic sub-group node from the plurality of synthetic sub-group nodes; and
expanding the selected synthetic sub-group node to display a sub-group of nodes and records corresponding to the selected synthetic sub-group node while displaying remaining synthetic sub-group nodes for unselected synthetic sub-group nodes.

9. The method of claim 3, further comprising:
marking an accessed queue node in the history queue with a time stamp when the node is expanded; and
ordering accessed queue nodes and accessed queue records in the history queue based on time stamps of the accessed queue nodes and accessed queue records.

10. The method of claim 9, wherein the accessed queue node in the history queue represents a parent node with a child node or a child record, and the accessed queue node has the time stamp of a child queue node or a child queue record when the child node or the child record is accessed more recently than the parent node.

11. The method of claim 10, wherein the accessed queue node is moved in order in the history queue relative to the time stamp.

12. The method of claim 3, wherein collapsing the oldest accessed node of the tree list displayed collapses a more recently accessed node when a child node or a child record of the oldest accessed node is accessed more recently than the more recently accessed node.

13. The method of claim 3, wherein saving the history queue further comprises:
accessing a prior accessed node by expanding the node; and
saving a prior accessed queue node in the history queue corresponding to the prior accessed node.

14. A system for managing the number of records displayed in a tree list 120, comprising:
a computing device 110 for generating a tree list 120 with expandable nodes;
a display unit 100 coupled to the computing device 110 for displaying the tree list 120;
a module for setting a limit 132 on the number of concurrently displayed nodes and records of the tree list 120;
a memory of the computing device 110 with the limit 132 set on the number of concurrently displayed nodes and records of the tree list 120 where the memory saves a history queue 130 of an access order of a plurality of nodes of the tree list 120;
an input device 140 or 142 coupled to the computing device 110 for selecting a recently accessed node of the tree list 120 to be displayed on the display unit 100;
a central processing unit (CPU) of the computing device 110 for collapsing an oldest accessed node of the history queue 130 when the number of concurrently displayed nodes and records exceeds the limit 132, and expanding the recently accessed node of a tree list 120 displayed on the display unit 100.

15. The system of claim 14, wherein the computing device displays the tree list using a browser application.
